(19) United States
(12) Patent Application Publication
(10) Pub. No.: US 2013/0335910 A1
(43) Pub. Date: Dec. 19, 2013

(54) MULTI FUNCTION SUPPORTER FOR A PORTABLE TERMINAL

(71) Applicant: Young-Suk Choi, Seoul (KR)

(72) Inventor: Young-Suk Choi, Seoul (KR)

(21) Appl. No.: 13/981,923

(22) PCT Filed: Feb. 8, 2012
(86) PCT No.: PCT/KR2012/000938

§ 371 Date: Jul. 26, 2013

(30) Foreign Application Priority Data
Feb. 8, 2011 (KR) 1020110010967
Feb. 7, 2012 (KR) 1020120012135

(51) Int. Cl. G06F 1/16

(52) U.S. Cl. CPC G06F 1/1684
USPC 361/679.31; 248/346.06

(57) ABSTRACT

Provided is a multi-function supporter for a portable terminal which has a novel structure so as to stably support the portable terminal. The multi-function supporter has a concave groove 11 having a shape corresponding to that of a second housing 20 on a lower surface of a first housing 10. Also, when the second housing 20 is laterally rotated and spread, the lower surface of the first housing 10 may be closely attached to a bottom surface to support the supporter without being laterally shaken. Thus, a portable terminal 1 mounted on the supporter may be prevented from laterally falling down or the supporter may be prevented from falling down together with the portable terminal 1, thereby allowing stable mounting of the portable terminal 1.

### TECHNICAL FIELD

The present invention relates to a multi-function supporter for a portable terminal which has a novel structure so as to stably support the portable terminal

### BACKGROUND ART

In recent years, various types of portable terminals such as mobile phones, smartphones, portable media players (PMP), portable game consoles, and the like have been developed and widely used.

In addition, along with an increase in such portable terminals, various types of supporters for allowing the portable terminal to be mounted thereon have been developed.

Meanwhile, an apparatus for function expansion of portable electronic equipment which may expand functions of a portable terminal while allowing various types of portable terminals to be mounted on the apparatus has been filed and registered by the present applicant (Patent No. 10-0740747).

The apparatus for function expansion of the portable electronic equipment includes a first housing 10 and a second housing 20 that is rotatably coupled laterally on a lower side of the first housing 10 as shown in FIGS. 1A and 1B. Each of the first housing 10 and the second housing 20 is formed into a long rectangular bar shape, and as shown in FIGS. 1B and 2, a portable terminal 1 may be mounted on an upper surface of the second housing 20 in a state in which the first housing 10 and the second housing 20 form 90° therebetween.

Here, in such an apparatus for function expansion of the portable electronic equipment, the first housing 10 and the portable terminal 1 are supported by the second housing 20, as shown in FIG. 2.

However, since a lateral width of the first housing 10 is significantly narrow, it is difficult to sufficiently support the portable terminal 1 when the portable terminal 1 is mounted on the apparatus for function expansion, and there is a problem that the portable terminal 1 mounted on the apparatus for function expansion laterally falls down, or the apparatus for function expansion laterally falls down together with the portable terminal 1.

Accordingly, there are demands for a new method that overcomes the above-described problem.

Meanwhile, a connection terminal for data communication and charge is formed on one side of such a portable terminal 1, data communication with a computer or other different types of portable terminals 1 may be performed by connecting a communication cable to the connection terminal, or charge may be performed by connecting a charger to the connection terminal

### DISCLOSURE

### Technical Problem

The present invention is directed to providing a multi-function supporter for a portable terminal which has a novel structure so as to stably support the portable terminal

### Technical Solution

One aspect of the present invention provides a multi-function supporter for a portable terminal includes: a first housing 10; and a second housing 20 configured to be rotatably coupled laterally on a lower side of the first housing 10, wherein a hook 21 protrudes upward from an upper surface of at least one end of the second housing 20 so that an overall surface of a lower end portion of the portable terminal 1 seated on the second housing 20 is mounted on the hook 21, a concave groove 11 having a shape corresponding to that of the second housing 20 is formed on a lower surface of the first housing 10, and a side surface of the concave groove 11 is opened in a lateral direction of the first housing 10 so that when the second housing 20 is laterally rotated and spread in a state in which the second housing 20 is embedded in the concave groove 11 of the first housing 10, the end of the second housing 20 is exposed toward a side surface of the first housing 10 to allow the portable terminal 1 to be mounted on an upper surface of the second housing 20.

The lower surface of the first housing 10 and a lower surface of the second housing 20 may form the same plane.

The hook 21 may be formed on upper surfaces of both ends of the second housing 20, and distances L1 and L2 from a rotating central shaft C of the second housing 20 to the hook 21 formed on the both ends of the second housing 20 may be different from each other.

A protrusion portion 12 may protrude from an end of the first housing 10 so that an end of the protrusion portion 12 has a round shape, and thereby enable to operate a touchscreen of the portable terminal using the protrusion portion 12.

The first housing 10 may be made of a conductive metal material.

The first housing 10 may be made of a non-conductive material, and a surface of the first housing 10 may be coated with conductive paint.

A capacitance type touch pen 13 may be slidably or rotatably coupled on one side of the first housing 10.

A USB plug 23 that is inserted and coupled to a USB terminal may be formed on one side of the first housing 10 or the second housing 20, and a memory chip 24 connected to the USB plug 23 may be provided in the first housing 10 or the second housing 20.

A USB plug 23 that is inserted and coupled to a USB terminal may be formed on one side of the second housing 20, and a connection plug 25 that is coupled with a connection terminal formed in the portable terminal 1 and connected to the USB plug 23 may be provided on an upper surface of the first housing 10.

The concave groove 11 may be opened toward a side surface and an end of the longitudinal direction of the first housing 10 so that the first housing 10 is rotated by 180° and spread.

### Advantageous Effects

A multi-function supporter for a portable terminal according to an exemplary embodiment of the present invention has a concave groove 11 having a shape corresponding to that of a second housing 20 on a lower surface of a first housing 10, so that when the second housing 20 is laterally rotated and spread, the lower surface of the first housing 10 may be closely attached to a bottom surface to support the supporter without being laterally shaken.

### DESCRIPTION OF DRAWINGS

FIGS. 1A and 1B are perspective views showing a multi-function supporter for a portable terminal according to the related art;

FIG. 2 is a reference view showing a multi-function supporter for a portable terminal according to the related art;

FIG. 3 is a perspective view showing a multi-function supporter for a portable terminal according to an embodiment of the present invention;

FIG. 4 is an exploded perspective view showing a multi-function supporter for a portable terminal according to an embodiment of the present invention;

FIG. 5 is a perspective view showing a state in which a second housing of a multi-function supporter for a portable terminal according to an embodiment of the present invention is rotated;

FIG. 6 is a cross-sectional view showing a multi-function supporter for a portable terminal according to an embodiment of the present invention;

FIG. 7 is a side view showing a state in which a multi-function supporter for a portable terminal according to an embodiment of the present invention is spread;

FIG. 8 is a front view showing a state in which a multi-function supporter for a portable terminal according to an embodiment of the present invention is used;

FIGS. 9 to 11 are reference views showing modification examples of a multi-function supporter for a portable terminal according to an embodiment of the present invention;

FIG. 12 is an exploded perspective view showing a second embodiment of a multi-function supporter for a portable terminal according to an embodiment of the present invention;

FIG. 13 is a perspective view showing a state in which a second embodiment of a multi-function supporter for a portable terminal according to an embodiment of the present invention is spread;

FIG. 14 is an exploded side view showing a third embodiment of a multi-function supporter for a portable terminal according to an embodiment of the present invention;

FIG. 15 is a reference view showing a state in which a third embodiment of a multi-function supporter for a portable terminal according to an embodiment of the present invention is used; and

FIG. 16 is a reference view showing a modification example of a third embodiment of a multi-function supporter for a portable terminal according to an embodiment of the present invention.

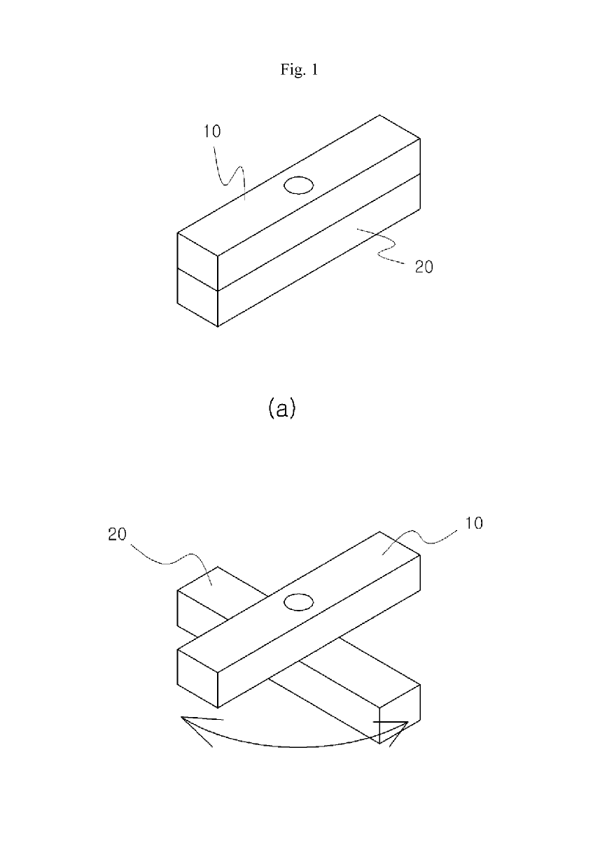

### MODES OF THE INVENTION

Hereinafter, exemplary embodiments of the present invention will be described in detail with reference to the accompanying drawings.

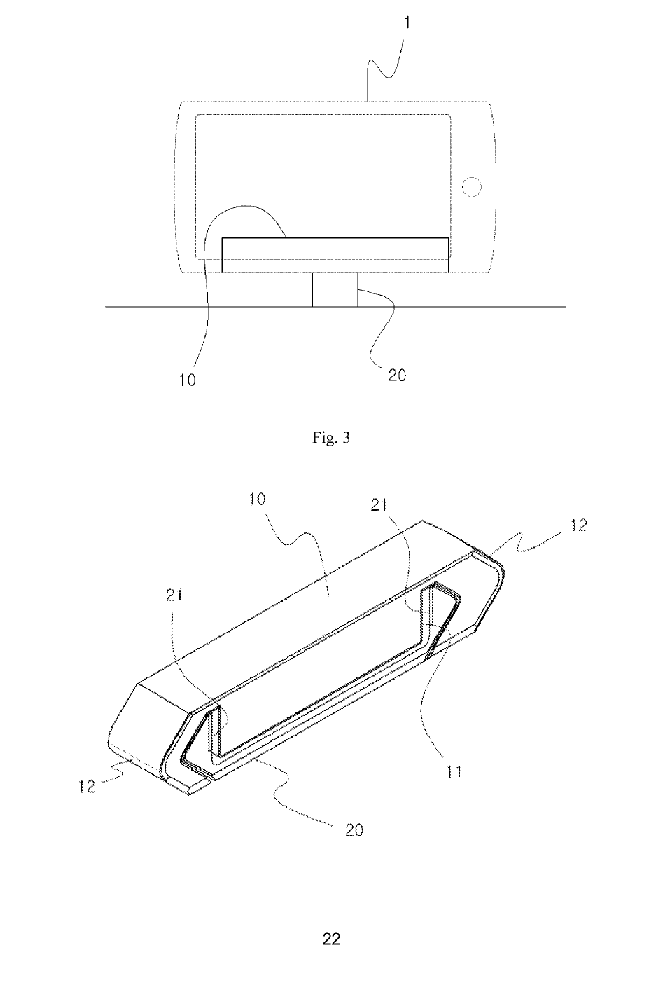

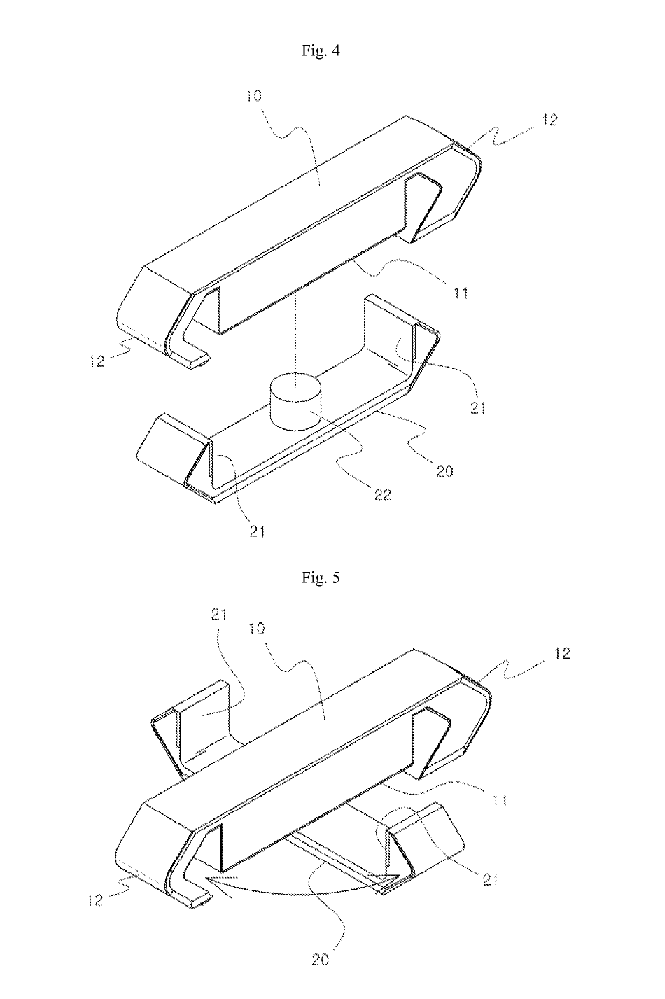

In FIGS. 3 to 8, a multi-function supporter for a portable terminal according to an embodiment of the present invention is shown, and includes a first housing 10 and a second housing 20 that is rotatably coupled laterally on a lower side of the first housing 10 like a multi-function supporter for a portable terminal according to the related art.

In this instance, a connection terminal for data communication and charge is formed on one side of the portable terminal 1, so that data communication with a computer or other different types of portable terminals 1 may be performed by connecting a communication cable to the connection terminal, or charge may be performed by connecting a charger to the connection terminal. In addition, a constant pressure type or a capacitance type touchscreen is provided on a front surface of the portable terminal 1, so that the portable terminal 1 may be operated by touching the touchscreen using a finger or a touch pen by a user.

According to an embodiment of the present invention, a hook 21 protrudes upward from upper surfaces of both ends of the second housing 20 so that an overall surface of a lower end portion of the portable terminal 1 seated on the second housing 20 is mounted on the hook 21.

In this instance, each of the first housing 10 and the second housing 20 is formed into a long rectangular bar shape. A concave groove 11 having a shape corresponding to that of the second housing 20 is formed on a lower surface of the first housing 10, and a rotary shaft 22 rotatably coupled to the lower surface of the first housing 10 is provided on the upper surface of the second housing 20, so that the second housing 20 is embedded in the concave groove 11.

In this instance, the concave groove 11 is dented upward from the bottom surface of the first housing 10 with the same depth as a vertical height of the second housing 20 so that bottom surfaces of the first housing 10 and the second housing 20 form the same plane. Side surfaces of both sides of the concave groove 11 are opened in both side directions of the longitudinal direction of the first housing 10.

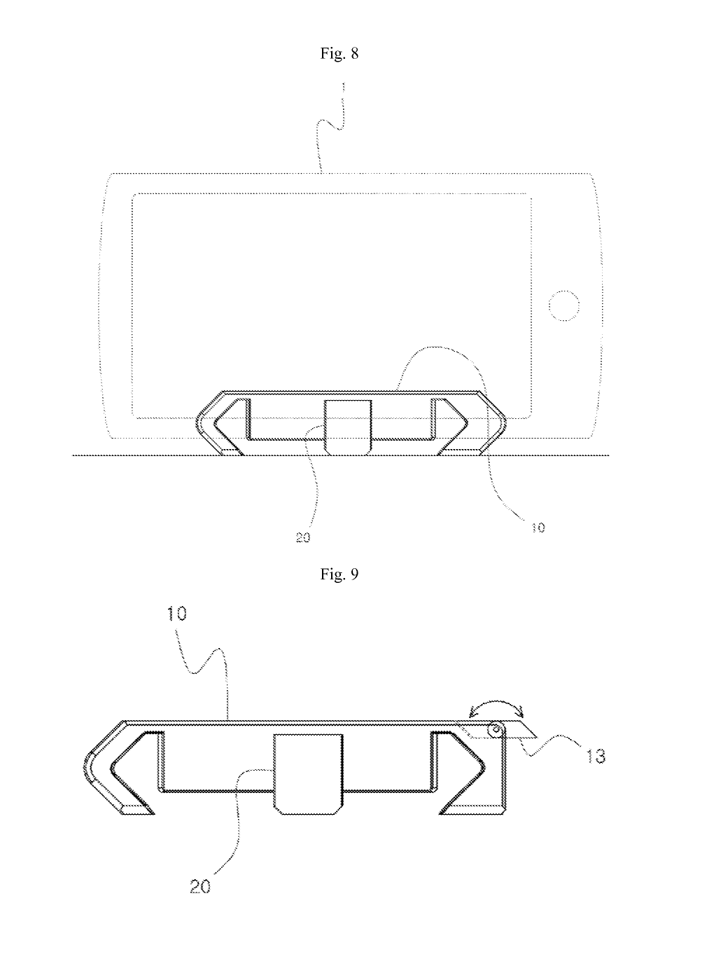

Accordingly, when the second housing 20 is laterally rotated and spread in a state in which the second housing 20 is embedded in the concave groove 11 of the first housing 10, an end of the second housing 20 is exposed toward a side surface of the first housing 10, and as shown in FIG. 7, when the portable terminal 1 is seated on the upper surface of the second housing 20, the portable terminal 1 is supported by the side surface of the first housing 10 and the upper surface and hook 21 of the second housing 20, so that the portable terminal 1 may be mounted on the second housing 20.

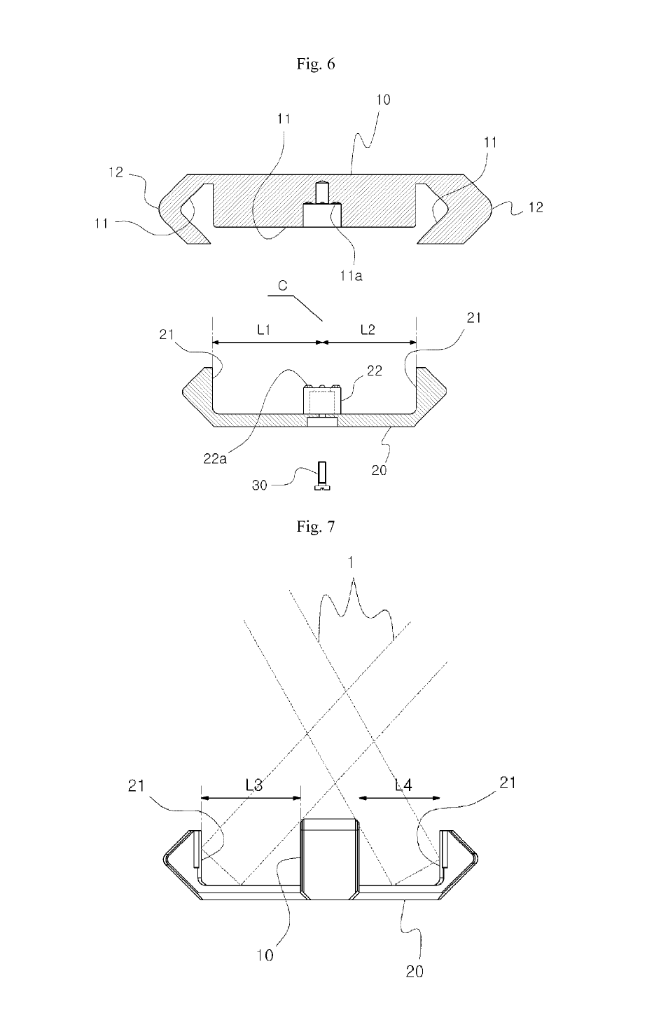

In this instance, as shown in FIG. 6, a protrusion 22a and a coupling groove 11a which are engaged with each other are formed in an upper end of the rotary shaft 22 and the concave groove 11 of the first housing 10 so that the second housing 20 is embedded in the concave groove 11 of the first housing 10 in parallel to the first housing 10, or the second housing 20 is rotated so as to form an angle of 90° with the first housing 10.

In addition, distances L1 and L2 from a rotating central shaft C of the second housing 20 to the hook 21 formed on the both ends of the second housing 20 may be different from each other. In this instance, the rotating central shaft C indicates a central axial line of the rotary shaft 22.

Accordingly, when the both ends of the second housing 20 protrude toward both sides of the first housing 10 by rotating the second housing 20 by 90°, as shown in FIG. 7, lengths L3 and L4 of which both ends of the second housing 20 protruded from the both side surfaces of the first housing 10 may be different from each other, so that the portable terminal 1 may be seated on one end of the first housing 10 or the other end thereof in accordance with a thickness of the seated portable terminal 1.

In addition, the first housing 10 is made of a conductive metal material, and a protrusion portion 12 protrudes from the both ends of the first housing 10 so that an end of the protrusion portion 12 has a round shape, and therefore the portable terminal 1 may be operated by touching a touchscreen of the portable terminal 1 through an end of the protrusion portion 12.

In this instance, since the first housing 10 has conductivity and the protrusion portion 12 has the round-shaped end, almost the same conductivity as when touching the touchscreen using a user's finger may be exhibited when touching the touchscreen of the portable terminal 1 through the end of the protrusion portion 12. In addition, a shape and an angle of a distal end of the protrusion portion 12 may be appropriately selected in accordance with conductivity of the first housing 10.

As a result, it is possible to operate a capacitance type touchscreen as well as a constant pressure type touchscreen.

A reference numeral 30 which is not described represents a fixing bolt that vertically penetrates through the rotary shaft 23 and is screw-coupled to the first housing 10 so that the second housing 20 is rotatably fixed to the first housing 10.

The multi-function supporter for the portable terminal configured in this manner has the concave groove 11 having the shape corresponding to that of the second housing 20 on the lower surface of the first housing 10, so that when the second housing 20 is laterally rotated and spread, the lower surface of the first housing 10 may be closely attached to the bottom surface to support the supporter without being laterally shaken. Therefore, the portable terminal 1 mounted on the supporter may be prevented from laterally falling down or the supporter may be prevented from falling down together with the portable terminal 1, thereby allowing stable mounting of the portable terminal 1.

In particular, the lower surfaces of the first housing 10 and the second housing 20 may form the same plane, and more specifically, when the supporter is seated on a floor surface while the second housing 20 is rotated and spread, the lower surface of the first housing 10 is brought into contact with the floor surface as shown in FIG. 8, and therefore the supporter may be more effectively prevented from falling down.

In addition, the distances L1 and L2 from the rotating central shaft C of the second housing 20 to the hook 21 formed on the both ends of the second housing 20 are different from each other, so that the lengths L3 and L4 of which both ends of the second housing 20 protruded from the both side surfaces of the first housing 10 are different from each other when the second housing 20 is laterally rotated by 90° and spread. Accordingly, the portable terminal 1 may be appropriately and selectively mounted on one end of the both ends of the second housing 20 in accordance with a thickness of the mounted portable terminal 1.

Alternatively, when desiring to nearly vertically erecting the portable terminal 1, the portable terminal 1 is mounted on the end having a shorter protrusion length of the both ends of the second housing 20, and when desiring to mounting the portable terminal in a laid state, the portable terminal 1 is mounted on the end having a longer protrusion length of the both ends of the second housing 20, and therefore an angle at which the portable terminal 1 is mounted may be adjusted as shown in FIG. 7.

In addition, the first housing 10 is made of a conductive metal material, and the protrusion portion 12 protrudes from the end of the first housing 10 so that an end of the protrusion portion 12 has a round shape, so that the capacitance type touchscreen as well as the constant pressure type touchscreen may be operated by touching the touchscreen through the protrusion portion 12. Accordingly, a separate touch pen is not required, and utilization of the supporter may be increased.

In the present embodiment, an example in which each of the first housing 10 and the second housing 20 has a long rectangular bar shape has been described, but each of the first and second housings 10 and 20 may be formed in various cross-sectional shapes such as a triangle or other polygons. Besides, each of the first and second housings 10 and 20 may be formed in various shapes such as a body and wings of a plane.

In the present embodiment, an example in which the first and second housings 10 and 20 are rotatably fixed by the fixing bolt 30 has been described, but a method of fixing the first and second housings 10 and 20 so as to be mutually rotatable may be diversely provided.

In addition, in the present embodiment, an example in which the first housing 10 is made of a conductive metal material and the protrusion portion 12 serves as a capacitance type touch pen has been described, but the first housing 10 may be made of a non-conductive material such as synthetic resins and a surface of the first housing 10 may be coated with conductive paint, so that appropriate conductivity may be granted to the first housing 10.

In addition, in the present embodiment, an example in which the protrusion portion 12 is formed on the end of the first housing 10 and a touchscreen is operated using the protrusion portion 12 has been described, but as shown in FIG. 9, a separate capacitance type touch pen 13 may be rotatably coupled to the first housing 10 so that a constant pressure type or a capacitance type touchscreen may be operated using the touch pen 13. In this instance, magnets may be provided in the touch pen 13 and the first housing 10, so that the touch pen 13 may be housed and fixed in the first housing 10.

In this instance, the touch pen 13 may be slidably coupled to the first housing 10.

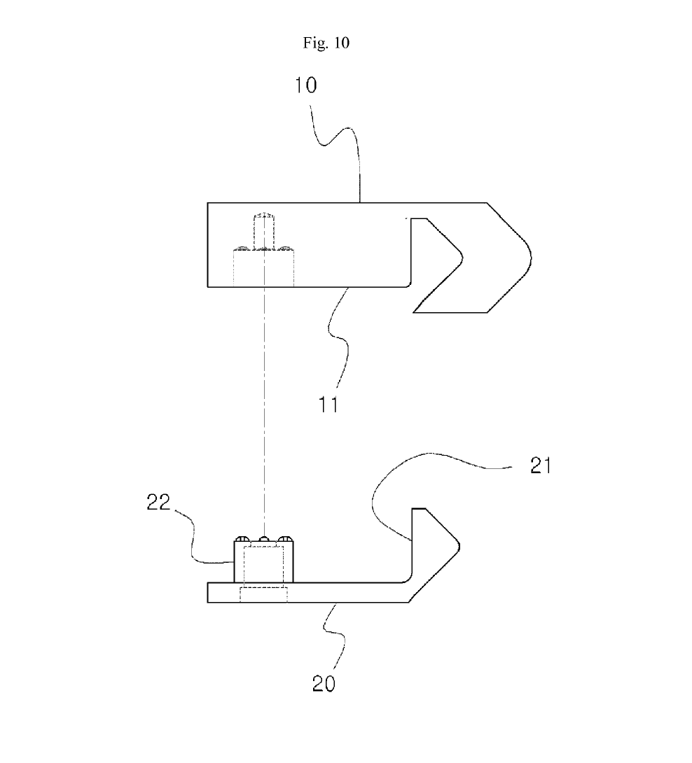

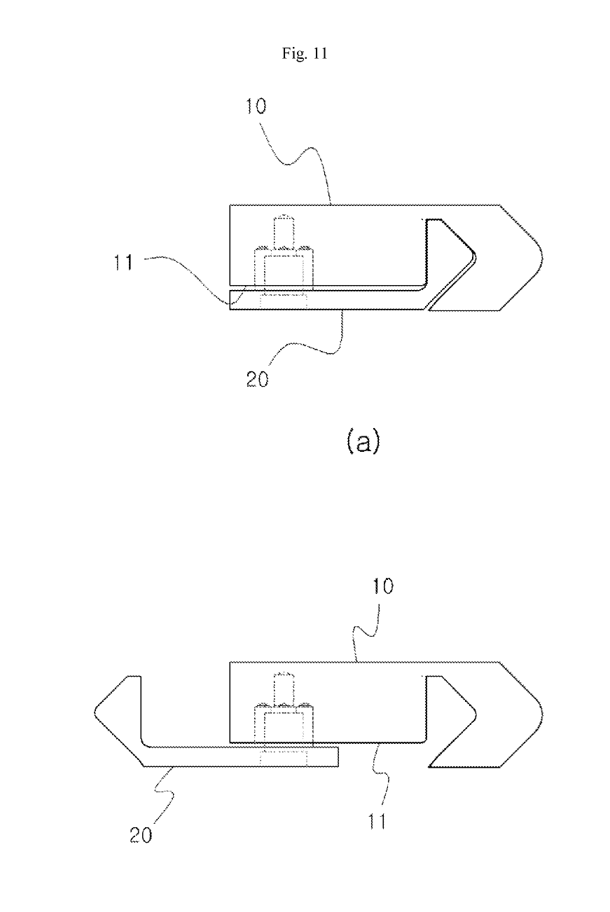

In addition, in the present embodiment, an example in which the both ends of the second housing 20 protrude in such a manner that the second housing 20 is rotated with respect to the first housing 10 by 90° has been described, but as shown in FIGS. 10 and 11, the concave groove 11 may be opened toward a side surface of the longitudinal direction of the first housing 10 and an end thereof, so that the first housing 10 may be rotated by 180° and spread.

In this case, the hook 21 is formed on only one side end of the first housing 10.

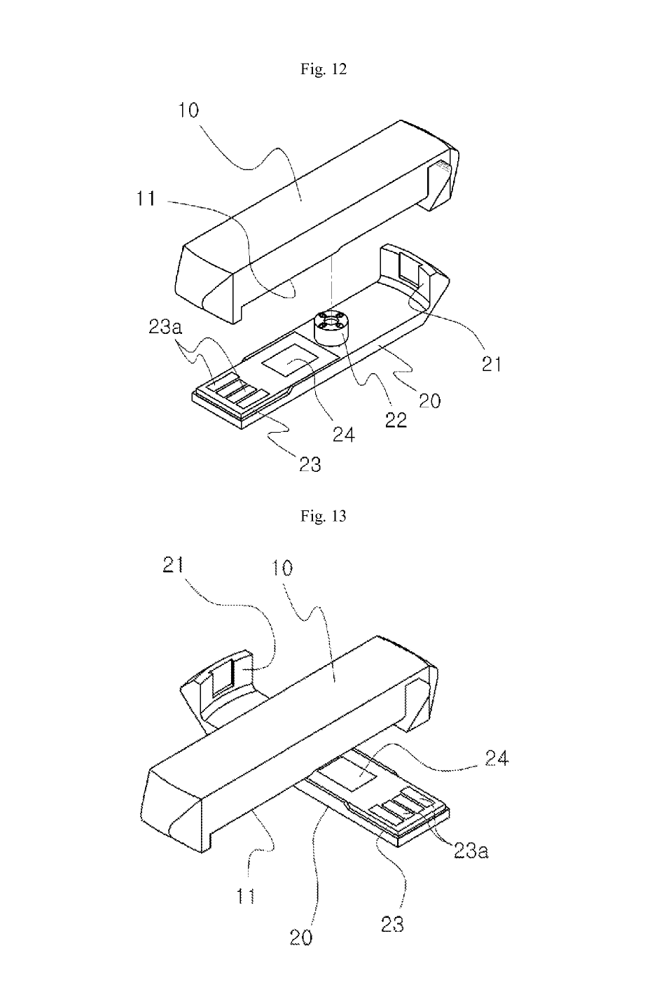

In FIGS. 12 and 13, another embodiment of the present invention is shown, a USB plug 23 that is inserted and coupled to a USB terminal is formed on one side of the second housing 20, and a memory chip 24 connected to the USB plug 23 is provided in the second housing 20.

To this end, the hook 21 is formed on only an upper surface of the end of the second housing 20.

The USB plug 23 on which a plurality of contact points 23a are provided is formed on the other end of the second housing 20. In this instance, a control circuit that stores, in the memory chip 24, data transmitted through the USB plug 23 or transmits the data stored in the memory chip 24 through the USB plug 23 is provided between the USB plug 23 and the housing.

Accordingly, in a state in which the USB plug 23 is coupled to a USB port provided in a computer or the portable terminal 1, it is possible to transmit the data stored in the memory chip 24 to the computer or the portable terminal 1 or to store, in the memory chip 24, data stored in the computer or the portable terminal 1.

A configuration and function of each of such a USB plug 23 and the memory chip 24 are the same as those of a USB plug and a memory chip which are provided in a widely used USB storage device, and thus detailed description thereof will be omitted.

The multi-function supporter for the portable terminal configured in this manner further has a function of a USB storage device as well as a simple function of mounting the portable terminal 1, thereby further enhancing utilization of the multi-function supporter for the portable terminal.

In particular, when using the portable terminal 1 including the USB terminal to which the USB plug 23 can be coupled, together with the multi-function supporter for the portable terminal according to the present invention, the multi-function supporter may be utilized as a backup storage device for backing up data of the portable terminal 1 without a separate external storage device, thereby further enhancing utilization of the supporter.

In the present embodiment, an example in which the USB plug 23 and the memory chip 24 are provided on one side of the second housing 20 has been described, but the USB plug 23 and the memory chip 24 may be provided on one side of the first housing 10.

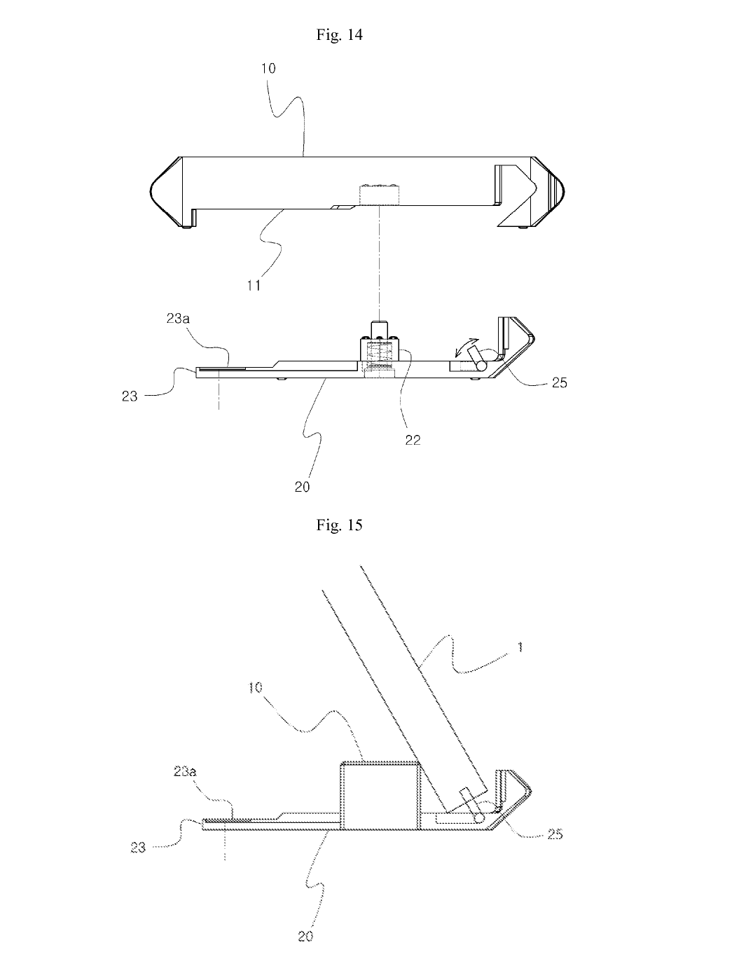

In FIGS. 14 and 15, a third embodiment of the multi-function supporter for the portable terminal according to the present invention is shown. Here, the USB plug 23 that is inserted and coupled to the USB terminal is formed on one side of the second housing 20, and a connection plug 25 that is coupled to a connection terminal formed in the portable terminal 1 and connected to the USB plug 23 is provided on an upper surface of the first housing 10.

The USB plug 23 is formed on the other end of the second housing 20 in the same manner as the above-described second embodiment.

As the connection plug 25, a widely used 14-pin, 20-pin, or 24-pin plug or a general connection plug such as a micro USB plug 23 is used, and the connection plug 25 is rotated to an upper surface of the second housing 20 so as to be folded and unfolded.

Accordingly, in a state in which the portable terminal 1 is mounted on the supporter so that the connection terminal of the portable terminal 1 is coupled to the connection plug 25, communication between the portable terminal 1 and a computer or between the portable terminal 1 and another portable terminal 1 may be performed by connecting the USB plug 23 to the USB terminal provided in the computer or the other portable terminal 1, or the portable terminal 1 may be charged using electric power applied through the USB plug 23.

In this manner, a configuration and function in which data communication or charge may be performed by connecting the connection plug 25 to the connection terminal of the portable terminal 1 and connecting the USB terminal connected to the connection plug 25 to the USB terminal provided in the computer or the other portable computer 1 are the same as a configuration and function of a communication cable for a general mobile phone, and thus the detailed description thereof will be omitted.

The multi-function supporter for the portable terminal functions as a docking station for a portable terminal that connects the portable terminal 1 to the computer or the other portable terminal 1, and therefore the portable terminal 1 may be more easily utilized as various applications.

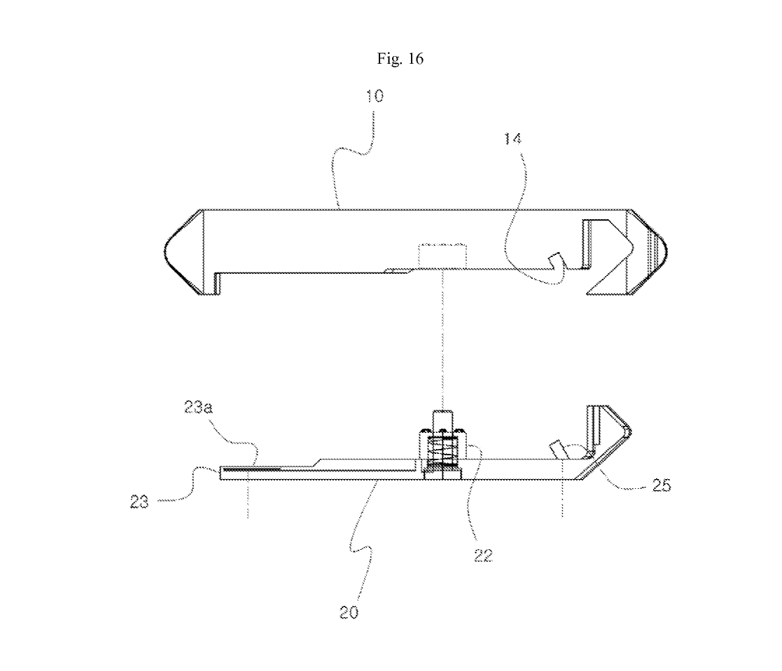

In the present embodiment, an example in which the connection plug 25 is rotatably coupled to the second housing 20 has been described, but as shown in FIG. 16, the connection plug 25 may be fixedly coupled to the second housing 20, and an insertion groove 14 corresponding to the connection plug 25 may be formed on the lower surface of the first housing 10, so that the connection plug 25 and the first housing 10 are prevented from interfering with each other.

In the above-described second and third embodiments, an example in which the USB plug 23 is formed on one end of the second housing 20 has been described, but the USB plug 23 may be retractably provided on one side of the first housing 10 or the second housing 20.

In addition, in the above-described second and third embodiments, an example in which any one of the memory 24 and the connection plug 25 is selected has been described, but the memory 24 and the connection plug 25 may be simultaneously provided in the second housing 20 so that a function of data storage using the memory 24 may be performed together with a function of data transmission and charge using the connection plug 25. In this instance, a separate control circuit or control program for controlling these functions may be mounted in the second housing 20 and the portable terminal 1.

While the invention has been shown and described with reference to certain exemplary embodiments thereof, it will be understood by those skilled in the art that various changes in form and details may be made therein without departing from the spirit and scope of the invention as defined by the appended claims.

### THE DESCRIPTION OF REFERENCE NUMERALS OF THE MAIN ELEMENTS IN DRAWINGS

1. Portable terminal
10. First housing
11. Concave groove
12. Protrusion portion
13. Touch pen
14. Insertion groove
20. Second housing
21. Hook
22. Rotary shaft
23. USB plug
24. Memory
25. Connection plug

1. A multi-function supporter for a portable terminal, comprising:
a first housing 10; and
a second housing 20 configured to be rotatably coupled laterally on a lower side of the first housing 10,
wherein a hook 21 protrudes upward from an upper surface of at least one end of the second housing 20 so that an overall surface of a lower end portion of the portable terminal 1 seated on the second housing 20 is mounted on the hook 21,
a concave groove 11 having a shape corresponding to that of the second housing 20 is formed on a lower surface of the first housing 10, and
a side surface of the concave groove 11 is opened in a lateral direction of the first housing 10 so that when the second housing 20 is laterally rotated and spread in a state in which the second housing 20 is embedded in the concave groove 11 of the first housing 10, the end of the second housing 20 is exposed toward a side surface of the first housing 10 to allow the portable terminal 1 to be mounted on an upper surface of the second housing 20.

2. The multi-function supporter of claim 1, wherein the lower surface of the first housing 10 and a lower surface of the second housing 20 form the same plane.

3. The multi-function supporter of claim 1, wherein the hook 21 is formed on upper surfaces of both ends of the second housing 20, and
distances L1 and L2 from a rotating central shaft C of the second housing 20 to the hook 21 formed on the both ends of the second housing 20 are different from each other.

4. The multi-function supporter of claim 1, wherein a protrusion portion 12 protrudes from an end of the first housing 10 so that an end of the protrusion portion 12 has a round shape, and thereby enables to operate a touchscreen of the portable terminal using the protrusion portion 12.

5. The multi-function supporter of claim 4, wherein the first housing 10 is made of a conductive metal material.

6. The multi-function supporter of claim 4, wherein the first housing 10 is made of a non-conductive material, and a surface of the first housing 10 is coated with conductive paint.

7. The multi-function supporter of claim 1, wherein a capacitance type touch pen 13 is slidably or rotatably coupled on one side of the first housing 10.

8. The multi-function supporter of claim 1, wherein a USB plug 23 that is inserted and coupled to a USB terminal is formed on one side of the first housing 10 or the second housing 20, and
a memory chip 24 connected to the USB plug 23 is provided in the first housing 10 or the second housing 20.

9. The multi-function supporter of claim 1, wherein a USB plug 23 that is inserted and coupled to a USB terminal is formed on one side of the second housing 20, and
a connection plug 25 that is coupled with a connection terminal formed in the portable terminal 1 and connected to the USB plug 23 is provided on an upper surface of the first housing 10.

10. The multi-function supporter of claim 1, wherein the concave groove 11 is opened toward a side surface and an end of the longitudinal direction of the first housing 10 so that the first housing 10 is rotated by 180° and spread.
